(19) United States
(12) Patent Application Publication
(10) Pub. No.: US 2016/0269539 A1
(43) Pub. Date: Sep. 15, 2016

(54) Cell phone driving detector

(71) Applicant: Antonio Chambers, Las Vegas, NV (US)

(72) Inventor: Antonio Chambers, Las Vegas, NV (US)

(21) Appl. No.: 14/544,984

(22) Filed: Mar. 12, 2015

(51) Int. Cl. H04M 1/725; H04M 15/00

(52) U.S. Cl. CPC H04M 1/72569; H04M 15/58

(57) ABSTRACT

The invention being mention was created to help stop texting and driving while operating a motor vehicles of all kind, and a better chance for safety. With this invention I believe that it will help save lives, create jobs, and revenue. The invention is a system device that will detect drivers using their cell phone, and help put a end to these senseless Injuries, and deaths that can be avoid with this new invention. Safety Is Our Priority.

The invention relates to the problems of texting and driving, or any motor vehicle cell phone use of any kind, except emergency only which are numbers (911) and that's all, Other calls, text or any other cell phone use while driving will be detected by the new and highly needed device system being designed particularly to stop cell phone use of any kind except 911 calls, titled Cell Phone Driving Detector. The invention will provide tracking of all motor vehicles that are operating a motor vehicle and using the cell phone, the invention will be applied in all motor vehicles on the driver side only, for the safety of all on the road, air, tracks, water, and land.

Long observation and study on the part of the application has led me to the conclusion that a large number of injuries and fatalities could be avoided if proper safety devices were placed on the driver side of all motor vehicles, this will allow for tracking of cell phone usage from any driver of a motor vehicle, this will make persons have no chose but to put down the cell phone knowing that there serious penalties and fines that will be charged to each driver that Cell Phone Driving Detector tracks. This sole purpose for the device system is for SAFETY. In order to provide safety to the roads, track, air, water, and land there has to be a penalty and fine so the operators of motor vehicles of all kind, realize this is serious, which will be determined by each U.S.A. govern judicial district across the globe. It is believed that there is no other way to minimize injuries or fatalities resulting from cell phone accidents than by furnishing proper safety device system for said motor vehicles. To that end, it has been an object of my invention to provide safety devices for said vehicles such as sensors or other similar devices which will effectively limit the use of cell phone by operator driving a motor vehicle, which will keep all occupants and others from avoidable injuries and fatalities.

Another object has been to provide safety devices of this kind which may be easily utilized and which may be arranged out of the way when in use or not in use.

Another object has been to provide safety devices of the kind described which are inexpensive to produce and simple to install.

These and other objects and advantages will appear more fully in hereafter specification when taken to connection with the accompanying abstract in which:

A sensor will be installed on the driver side of motor vehicles that will be for detecting any cell phone activity by the operator of motor vehicles while driving. If the operator of a car uses their cell phone except to dial 911, the sensor will send a signal to the municipal building in each district of each town, city, state, or country, letting the department know that a operator of a motor vehicle is using their cell phone, and their identity. That data will inform the department of who the phone belongs to and what transactions were made by the operator of the motor vehicle. Along with the sensor there will be IP, actuators, wire and wireless networks, satellite, silicon chips, and computers for detecting, collecting, tracking, analyzing, storage, penalty, and fine fees. What is revolutionary in all this is that the invention physical information system being deployed can work largely without human intervention. The data collected from the invention will be transferred to the municipal building to the DMV, when all data is finalized the DMV will send the offender there fine amount owed which will be determined by the courts, of each town, city, state, or country. If the each state were to use the invention, manufacturing process studded with a multitude of sensors can be controlled more precisely raising efficiency, and operating environments are monitored continuously for hazards to bring a handle on cell phone use while operating a motor vehicle. The invention will sever to all motor vehicle operators of all kind on roads, land, air, tracks, water, and highways and byways, for a whole new approach to safety for the now, and the future.

While I have described the preferred form of construction for carrying out my invention into effect, this is capable of variation and modification without departing from the spirit of the invention. I therefore, do not wish to be limited to the precise details of construction set forth, but desire to avail myself of such variations and modifications as come within the scope of the appended claims.

Having described my invention, what I claim as new and desire to secure by Letters Patent is:

1. In a safety device of the kind described for motor vehicles of all kind, a sensor, actuators, installed on the operating side of the motor vehicle to allow for identification tracking, sending signals to other department for monitoring of cell phone use while operating a motor vehicle of any kind.

2. In a safety device of the kind described, the silicon chips, computers, software to aggregate and analyze data as well graphic display technique to the point where huge volumes of data can be absorbed for human decision makers or synthesized to guide automated system such as the invention Cell Phone Driving Detector.

3. In a safety device of the kind described, the mobile 911 use.

4. In a safety device of the kind described, the infrastructure and construction of the invention and its operation.

5. In a safety device of the kind described, the mobile limited use except 911.

6. In a safety device of the kind described, the name Cell Phone Driving Detector.
